(19) United States
(12) Patent Application Publication
(10) Pub. No.: US 2006/0227749 A1
(43) Pub. Date: Oct. 12, 2006

(54) Channel estimation for a cdma system using pilot symbols

(76) Inventors: Xuejun Zhang, Shanghai (CN); Yueheng Li, Shanghai (CN)

Correspondence Address: PHILIPS INTELLECTUAL PROPERTY & STANDARDS, P.O. BOX 3001, BRIARCLIFF MANOR, NY, 10510, US

(21) Appl. No.: 10/555,268

(22) PCT Filed: Apr. 29, 2004
(86) PCT No.: PCT/IB04/50555

§ 371 Date: Nov. 1, 2005

(30) Foreign Application Priority Data
May 6, 2003 (CN) 03128689.5

(51) Int. Cl. H04B 7/216

(52) U.S. Cl. 370/335; 370/342

(57) ABSTRACT

The present invention provides a CDMA based communication system with improved channel estimation capability with respect to multiple pilots transmitted via channels dedicated to the system. In one embodiment of the invention, a CDMA based communication system compares the received multiple pilots to one another and selects a pilot with the largest power level. The channel estimation is performed based on the pilot with the largest power level to derive the associated channel parameters. The information intended for the system is then demodulated, based on the associated channel parameters, to retrieve user data In another embodiment of the invention, a CDMA based communication system first performs channel estimation on each of the dedicated channels, via each of which a pilot is received by the system, to derive channel parameters associated with each channel. Then all the channel parameters are combined to derive final channel parameters. The information intended for the system is demodulated, based on the final channel parameters, to retrieve user data. In this way, more precise channel parameters can be obtained.

### BACKGROUND OF THE INVENTION

The invention relates generally to wireless communication systems, and more particularly to code division multiple access (CDMA) communication systems with improved channel estimation capability with respect to multiple pilots transmitted via dedicated channels.

It is well known that in CDMA based wireless networks pilot data are used by a mobile terminal for estimating the channel to help demodulate useful user data, such as voice and control data, from information transmitted by a base station. The pilot data are known to both the mobile terminal and the base station through signaling. By comparing the received signals fetched at fixed time intervals during which the pilot is transmitted, with the originally known pilot data, the mobile terminal can estimate the complex baseband channel information to retrieve the useful information transmitted via parallel channels along with the pilot. In most cases, only one dedicated pilot channel is provided for each mobile terminal allotted with multiple dedicated channels. However, in some environments, e.g., in a situation where a mobile user is far away from the base station, especially when there is also a severe fading or shadow effect, the single pilot may not be adequate for channel estimation by the mobile terminal to retrieve the useful information.

Other pilots transmitted on common channels for all users have been used for channel estimation. Usually there exists a stream of pilot symbols from the available common channels, such as the broadcasting channel (BCH), forward access channel (FACH), and paging channel (PCH). In this case, a search is made to find the pilot signal with the largest power from the single channel dedicated to the user and other common channels for all users. Then this pilot signal is used for channel estimation and data demodulation.

However, in the above approach, the pilots are not always present in the common channels. This may cause disruptions in the communications, since if a pilot is needed for channel estimation it may not be available.

Therefore, there is a need for a communication system with improved channel estimation capability with respect to multiple pilots transmitted via dedicated channels.

### SUMMARY OF THE INVENTION

The present invention provides a CDMA based communication system with improved channel estimation capability with respect to multiple pilots. In this invention, the additional pilots are transmitted along with the original pilot, via channels dedicated the communication system. These additional pilots are used in case the original pilot has weak signal strength.

According to a first embodiment of the invention, a CDMA based communication system is provided and comprises a receiver, a comparator, a channel estimation circuit and a demodulator. The receiver receives information intended for the system, via a plurality of dedicated channels. The information includes multiple pilots from at least two of the channels. The comparator compares the powers of the multiple pilots to one another and outputs a pilot with the largest power level. The channel estimation circuit then performs channel estimation based on the pilot with the largest power level to derive associated channel parameters. In this way, the channel parameters can be better estimated. Finally, the demodulator demodulates the information intended for the system, based on the associated channel parameters, to retrieve user data.

According to a second embodiment of the invention, a CDMA based communication system is provided and comprises a receiver, a channel estimation circuit, a combining circuit and a demodulator. The receiver receives information intended for the system, via a plurality of dedicated channels. The information includes multiple pilots from at least two of the channels. The channel estimation circuit performs channel estimation on each of the dedicated channels, via each of which a pilot is received by the system, to derive channel parameters associated with each channel. The combining circuit then combines all the channel parameters to derive final channel parameters for outputting. In this manner, more precise channel parameters can be obtained. Finally, the demodulator demodulates the information intended for the mobile terminal, based on at least the output of the combining circuit, to retrieve user data.

A third embodiment of the invention basically combines the first and second embodiments described above.

Other objects and attainments together with a fuller understanding of the invention will become apparent and appreciated by referring to the following description and claims taken in conjunction with the accompanying drawings.

### BRIEF DESCRIPTION OF THE DRAWINGS

The invention is explained in further detail, and by way of example, with reference to the accompanying drawings wherein:

FIG. 1 illustrates information transmitted by a base station through n parallel channels dedicated to a mobile terminal;

FIG. 2 illustrates a channel estimation and data demoduation circuit of a mobile terminal according to a first embodiment of the invention;

FIG. 3 illustrates a channel estimation and data demoduation circuit of a mobile terminal according to a second embodiment of the invention; and

FIG. 4 illustrates a channel estimation and data demoduation circuit of a mobile terminal according to a third embodiment of the invention.

Throughout the drawings, the same reference numerals indicate similar or corresponding features or functions.

### DETAILED DESCRIPTION OF THE PREFERRED EMBODIMENTS

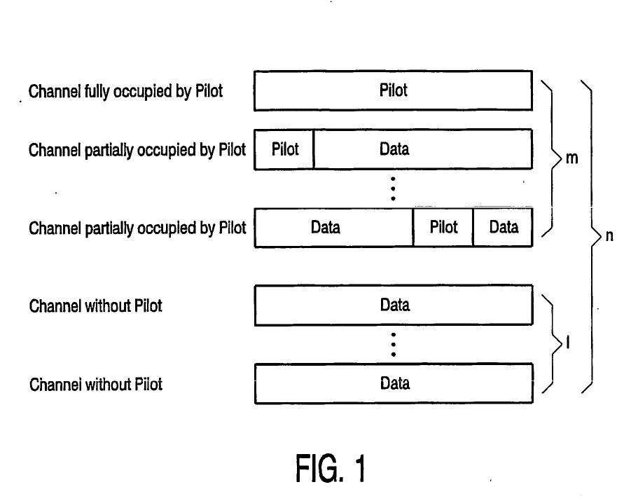

FIG. 1 illustrates information transmitted by a base station after signaling, through n parallel channels dedicated to a mobile terminal, in a CDMA based system, e.g., CDMA IS-95, CDMA2000, WCDMA (particularly WCDMA-HSDPA (high speed data packet access)).

As shown in FIG. 1, among the n dedicated channels, there are m channels through which multiple pilots are transmitted. Each pilot can occupy all or part of a channel, and the position of the pilot may be different in each channel. In the remaining l channels (e.g., the dedicated physical data channel (DPDCH) in WCDMA), data without pilots are transmitted. According to the invention, it is necessary to have at least two pilots transmitted through the dedicated channels within some time duration.

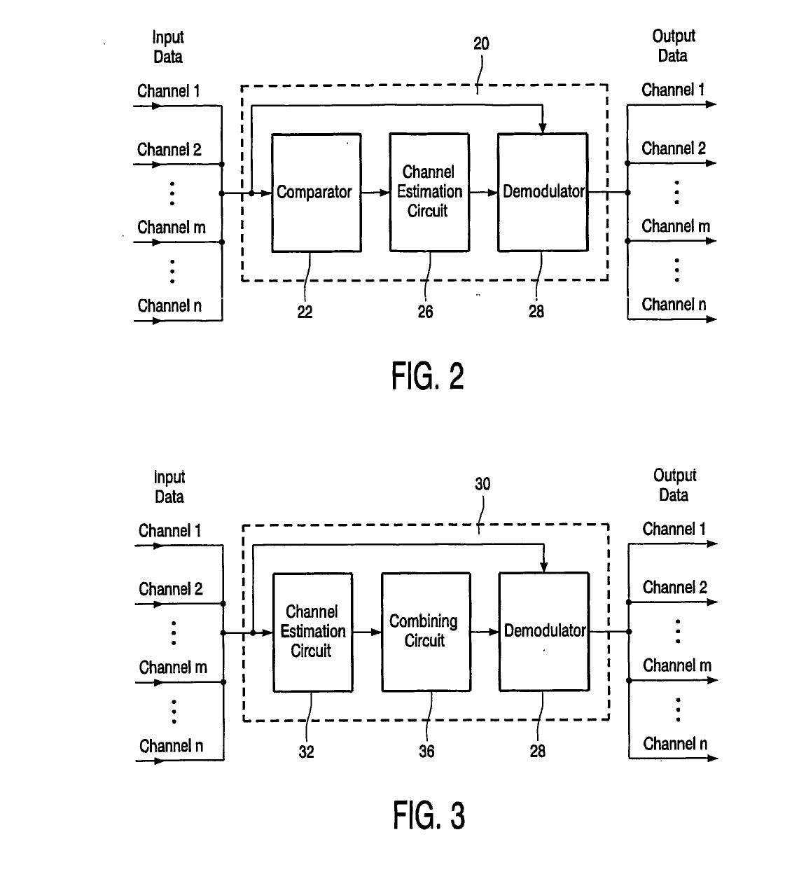

FIG. 2 illustrates a channel estimation and data demodulation circuit of a mobile terminal 20 according to a first embodiment of the invention. Mobile terminal 20 includes a comparator 22, a channel estimation circuit 26, a demodulator 28 and other conventional components (e.g., an antenna). For simplicity, these conventional components are not shown.

In FIG. 2, the input data have already been processed as baseband signals and time aligned. Comparator 22 measures the powers (i.e., the signal strength) of the pilots received from all the dedicated channels, and compares them against each other. Then a single pilot with the largest power is selected by comparator 22 as the real pilot and is output to channel estimation circuit 26. Based on the pilot selected by comparator 22, estimation circuit 26 performs channel estimation in a conventional manner to estimate the channel fading parameters. These parameters are provided to demodulator 28 for demodulation of the received signals in a conventional manner. After de-scrambling and de-spreading the received signals, demodulator 28 obtains the user data from the received signals and provides them as the output data to the output devices (e.g., a display and a speaker) of mobile terminal 20.

FIG. 3 illustrates a channel estimation and data demodulation circuit of a mobile terminal 30 according to a second embodiment of the invention. Mobile terminal 30 includes a channel estimation circuit 32, a combining circuit 36, a demodulator 28 and other components. Again, for simplicity, these conventional components are not shown. Also, the input data have already been processed as baseband signals and time aligned.

In FIG. 3, estimation circuit 32 carries out the channel estimation by separately estimating each channel in a conventional manner, using the pilot received from the respective channel. The channel estimations can be performed either in parallel or in series. The channel fading parameters obtained for each channel are then sent to combining circuit 36.

Combining circuit 36 then combines all the parameters received for each channel by performing an arithmetic addition on them to derive a final result. For example, assume that there are two channels. The channel fading parameters for channel 1 are (A₁e^{jφ+n}₁), and the parameters from channel 2 are (A₂e^{jφ+n}₂), where A₁ and A₂ are power amplitudes, φ is a phase, and n₁ and n₂ are complex noise. Combining circuit 36 combines the parameters to derive a final result of (A₁+A₂)e^{jφ}+(n₁+n₂). The final result from combining circuit 36 is provided to demodulator 28 for use to demodulate the received signals in a conventional manner. After de-spreading and de-scrambling the received signals, demodulator 28 obtains the user data from the received signals and provides them as the output data to output devices of mobile terminal 30.

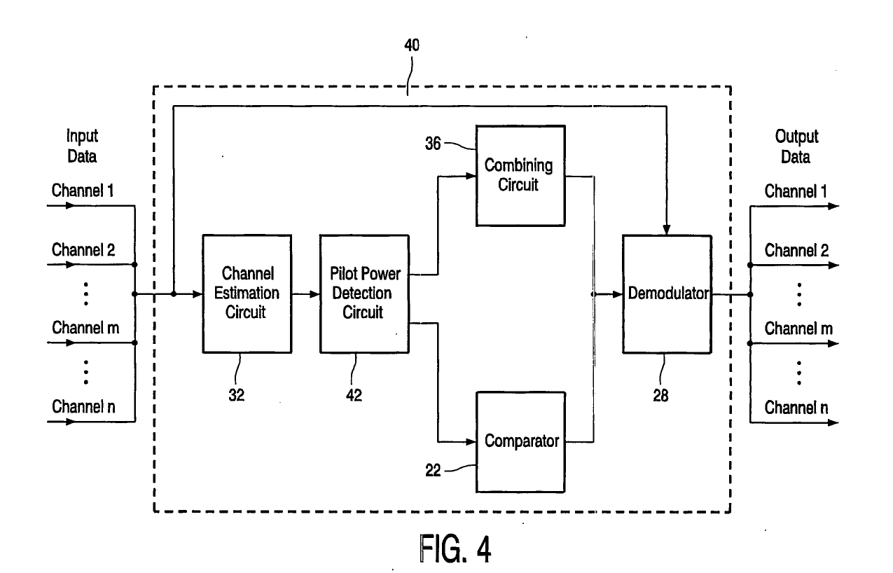

FIG. 4 illustrates a channel estimation and data demodulation circuit of a mobile terminal 40 according to a third embodiment of the invention. This embodiment combines the first and second embodiments described above. As shown in FIG. 4, mobile terminal 40 includes a channel estimation circuit 32, a pilot power detection circuit 42, a comparator 22, a combining circuit 36, a demodulator 28, and other conventional components.

In FIG. 4, estimation circuit 32 carries out the channel estimation by separately estimating each channel in a conventional manner, using the pilot received from the channel. The channel fading parameters obtained for each channel are then sent to detection circuit 42. Detection circuit 42 calculates a difference of two power amplitudes from the respective parameters for all possible combinations of the power amplitudes to find the largest difference. If the largest difference is not greater than a predetermined threshold value (e.g., 20% of the largest power amplitude from all the parameters), the parameters output by estimation circuit 32 win be provided to comparator 22 for comparisons of their power amplitudes in a manner similar as in the first embodiment above. Otherwise, these parameters will be provided to combining circuit 36 for combining in the same manner as in the second embodiment above. In the above, other ways of evaluating the power amplitudes by detection circuit 42 are also possible for deciding whether it is more effective to use the approach in the first embodiment or that in the second embodiment.

Depending on the detection result as determined by detection circuit 42, demodulator 28 will receive an output from either comparator 22 or combining circuit 36 for use to demodulate the received signals. In either case, after de-scrambling and de-spreading the received signals, demodulator 28 obtains the user data from the received signals and provides them as the output data to output devices of mobile terminal 40.

In the above, the invention has been illustrated in conjunction with a mobile terminal. The invention can also be used in the transceiver of a base station.

While the invention has been described in conjunction with specific embodiments, it is evident that many alternatives, modifications and variations will be apparent to those skilled in the art in light of the foregoing description. Accordingly, it is intended to embrace all such alternatives, modifications and variations as fall within the spirit and scope of the appended claims.

1. A circuit for use in a CDMA based communication system that has a receiver for receiving information intended for the system, via a plurality of dedicated channels, the information including multiple pilots from at least two of the channels, the circuit comprising:
a comparator that compares the powers of the multiple pilots from the plurality of dedicated channels to one another and outputs a pilot with the largest power level; and
a channel estimation circuit that is configured to perform channel estimation based on the pilot with the largest power level to derive associated channel parameters.

2. A circuit for use in a CDMA based communication system that has a receiver for receiving information intended for the system, via a plurality of dedicated channels, the information including multiple pilots from at least two of the channels, the circuit comprising:
a channel estimation circuit that is configured to perform channel estimation on each of the dedicated channels, via each of which a pilot is received by the system, to derive channel parameters associated with each channel; and
a combining circuit that is configured to combine all the channel parameters to derive final channel parameters.

3. The circuit of claim 1, further comprising a demodulator that demodulates the information intended for the system to retrieve user data.

4. The circuit of claim 2, further comprising:
a detection circuit that is configured to evaluate the power amplitudes of the parameters to obtain an evaluation result and compare the evaluation result against a predetermined threshold value to generate a control signal; and
a comparator for comparing the powers amplitudes of the parameters to one another to output the largest power amplitude, the comparator making the comparison if the control signal indicates that the evaluation result is not greater than the threshold value;
wherein the combining circuit combines all the channel parameters if the control signal indicates that the evaluation result is greater than the threshold value.

5. The circuit of claim 4, wherein the detection circuit evaluates the power amplitudes by calculating a power difference between each pair of the parameters for all possible combinations of the parameters and selecting a maximum power difference as the evaluating result.

6. The circuit of claim 4, further comprising a demodulator that demodulates the information intended for the system, based on an output from one of the comparator and the combining circuit, to retrieve user data.

7. A CDMA based communication system, comprising:
a receiver that receives information intended for the system, via a plurality of dedicated channels, the information including multiple pilots from at least two of the channels;
a comparator that compares the powers of the multiple pilots to one another and outputs a pilot with the largest power level;
a channel estimation circuit that is configured to perform channel estimation based on the pilot with the largest power level to derive associated channel parameters; and
a demodulator that demodulates the information intended for the system, based on the associated channel parameters, to retrieve user data.

8. A CDMA based communication system, comprising:
a receiver that is configured to receive information intended for the mobile terminal, via a plurality of dedicated channels, the information including multiple pilots from at least two of the channels;
a channel estimation circuit that is configured to perform channel estimation on each of the dedicated channels, via each of which a pilot is received by the system, to derive channel parameters associated with each channel;
a combining circuit that is configured to combine all the channel parameters to derive final channel parameters for outputting; and
a demodulator that is configured to demodulate the information intended for the system, based on at least an output of the combining circuit, to retrieve user data.

9. The system of claim 8, wherein the combining circuit combines all the channel parameters by performing arithmetic addition on these channel parameters.

10. The system of claim 8, further comprising:
a detection circuit that is configured to evaluate the power amplitudes of the parameters to obtain an evaluation result and compare the evaluation result against a predetermined threshold value to generate a control signal; and
a comparator for comparing the powers amplitudes of the parameters to one another to output the largest power amplitude, the comparator making the comparison if the control signal indicates that the evaluation result is not greater than the threshold value;
wherein the combining circuit combines all the channel parameters if the control signal indicates that the evaluation result is greater than the threshold value;
wherein the demodulator demodulates the information intended for the system, based on an output from one of the comparator and the combining circuit, to retrieve user data.

11. The system of claim 10, wherein the detection circuit evaluates the power amplitudes by calculating a power difference between each pair of the parameters for all possible combinations of the parameters and selecting a maximum power difference as the evaluating result.

12. A method for use in a CDMA based communication system that has a receiver for receiving information intended for the system, via a plurality of dedicated channels, the information including multiple pilots from at least two of the channels, the method comprising the steps of:
comparing the powers of the multiple pilots from the plurality of dedicated channels to one another;
outputting a pilot with the largest power level; and
performing channel estimation based on the pilot with the largest power level to derive associated channel parameters.

13. A method for use in a CDMA based communication system that has a receiver for receiving information intended for the system, via a plurality of dedicated channels, the information including multiple pilots from at least two of the channels, the method comprising the steps of:
performing channel estimation on each of the dedicated channels, via each of which a pilot is received by the system, to derive channel parameters associated with each channel;
outputting the channel parameters associated with each channel; and
combining all the channel parameters to derive final channel parameters.

14. The method of claim 12, further comprising the step of demodulating the information intended for the system to retrieve user data.

15. The method of claim 13, further comprising the steps of:
evaluating the power amplitudes of the parameters to obtain an evaluation result;
comparing the evaluation result against a predetermined threshold value to generate a control signal; and
comparing the powers amplitudes of the parameters to one another to output the largest power amplitude, if the control signal indicates that the evaluation result is not greater than the threshold value;
wherein the combining step is performed if the control signal indicates that the evaluation result is greater than the threshold value.

16. The method of claim 15, wherein the evaluating step is performed by calculating a power difference between each pair of the parameters for all possible combinations of the parameters and selecting a maximum power difference as the evaluating result.

17. The method of claim 15, further comprising the step of demodulating the information intended for the system, based on an output from one of the largest power amplitude and the final channel parameters, to retrieve user data.
